(19) United States
(12) Patent Application Publication
(10) Pub. No.: US 2016/0147311 A1
(43) Pub. Date: May 26, 2016

(54) KEYBOARD

(71) Applicants: BOE TECHNOLOGY GROUP CO., LTD., Beijing (CN); HEFEI XINSHENG OPTOELECTRONICS TECHNOLOGY CO., LTD., Hefei City (CN)

(72) Inventors: Xianlin DING, Beijing (CN); Ming HU, Beijing (CN); Ting ZENG, Beijing (CN)

(21) Appl. No.: 14/806,787

(22) Filed: Jul. 23, 2015

(30) Foreign Application Priority Data
Nov. 24, 2014 (CN) 201410686663.3

(51) Int. Cl. G06F 3/02; G06F 3/041; G06F 3/0354; G06F 3/0488

(52) U.S. Cl. CPC G06F 3/021; G06F 3/04886; G06F 3/04883; G06F 3/0412; G06F 3/03547

(57) ABSTRACT

A keyboard comprises a touch screen which identifies and responds to a touch action, wherein information is input through the touch screen. The above keyboard can enable the user to input information through the touch screen, which brings the user a more convenient and fast operation experience. And meanwhile, the user performs touching control operation on the keyboard without touching the display far from the user, thereby making the touch operation more convenient.

### TECHNICAL FIELD

Embodiments of the present disclosure relate to a keyboard.

### BACKGROUND

With the development of technology, touch display screens are widely used in electronic equipments such as smartphones, laptops, and the like, and in addition to being used for display, touch display screens are also served as information input devices on the above electronic equipments with touch display screens. When in use, users can input information (the input information including not only the text and other information, but also control instructions, such as slide-up, slide-down, scrolling, and so on) by pressing and sliding a touch screen; in comparison to traditional information input devices such as keyboards and mouse, sliding operations can bring people more convenient experience in terms of browsing the Web, pictures, as well as entertainment.

The touch screen is also applied to a laptop, a desktop, or the like, which enables slide operations so as to improve the operation experience in terms of browsing the Web, pictures, entertainment, etc. However, as for the laptop or desktop, especially for the desktop, there generally exists a long distance between the monitor and the user, it is not too convenient for the user to input information on the touch screen through the pressing and sliding operations; furthermore, the input efficiency of the way of inputting information through pressing the touch screen is low, and most desktops are used for Office, there has a higher requirement for the information inputting efficiency, so the way of inputting information through the touch screen is difficult to meet the operation requirement of desktops.

Therefore, how to provide an information inputting device is a technical problem to be solved by the persons skilled in the art, which can input information (the input information is generally represented as a control instruction) conveniently through sliding operation and has higher inputting efficiency at a far distance from the display.

### SUMMARY

At least one embodiment of the present disclosure provides a keyboard comprising a touch screen which identifies and responds to a touch action, wherein information is input through the touch screen of the keyboard.

In one embodiment according to the present disclosure, the touch screen is provided with a virtual key region in which virtual keys are provided and through which information are input in response to pressing on the virtual keys.

In one embodiment according to the present disclosure, the virtual key region of the touch screen only identifies and responds to the touch action on the virtual keys.

In one embodiment according to the present disclosure, the touch screen comprises a sliding operation region through which information is input by identifying and responding to the pressing and sliding on the touch screen.

In one embodiment according to the present disclosure, the aspect ratio of the sliding operation region is consistent with the aspect ratio of the display.

In one embodiment according to the present disclosure, the keyboard further comprises physical keys provided on a surface opposite to the surface on which the touch screen is located.

In one embodiment according to the present disclosure, the keyboard further comprises a support device which supports the keyboard at a surface where the touch screen is located or a surface where physical keys are located, to separate the touch screen or physical keys from the support surface for placing the keyboard.

In one embodiment according to the present disclosure, the support device has an end hinged to the keyboard.

In one embodiment according to the present disclosure, the keyboard comprises a gravity sensing device for sensing an orientation of the touch screen.

In one embodiment according to the present disclosure, the touch screen turns off when facing downward and turns on when facing upward.

The keyboard according to at least one embodiment of the present disclosure is provided with a touch screen, the user can input information through the touch screen, which brings the user a more convenient and fast operation experience; furthermore, the user performs a touching control operation on the keyboard without touching the display screen far from the user, thereby making the touching operation more convenient.

### BRIEF DESCRIPTION OF THE DRAWINGS

In order to clearly illustrate the technical solution of the embodiments of the present disclosure, the drawings of the embodiments will be briefly described in the following; it is obvious that the described drawings are only related to some embodiments of the present disclosure and thus are not limitative of the present disclosure.

FIG. 1 is a front schematic diagram of a keyboard according to one embodiment of the present disclosure;

FIG. 2 is a back schematic diagram of the keyboard according to one embodiment of the present disclosure; and

FIG. 3 is a side schematic diagram of the keyboard as illustrated in FIG. 2.

### DETAILED DESCRIPTION

In order to make objects, technical details and advantages of the embodiments of the present disclosure apparent, the technical solutions of the embodiment will be described in a clearly and fully understandable way in connection with the drawings related to the embodiments of the present disclosure. It is obvious that the described embodiments are just a part but not all of the embodiments of the present disclosure. Based on the described embodiments herein, those skilled in the art can obtain other embodiment(s), without any inventive work, which should be within the scope of the present disclosure.

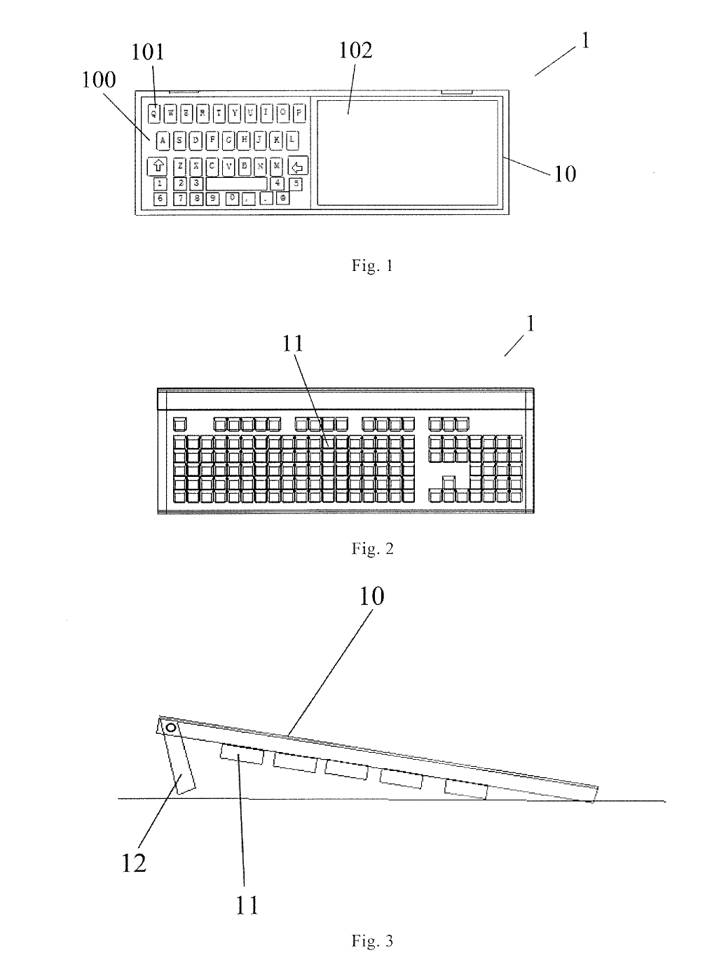

Referring to FIG. 1, FIG. 1 is a front schematic diagram of a keyboard according to one embodiment of the present disclosure. In this embodiment, a keyboard 1 comprises a touch screen 10 which is capable of identifying and responding to a touch action, and thus information can be input through the touch screen 10; the information includes not only the text information but also control instructions, such as slide-up, slide-down, scrolling, pressing keys, opening or closing a window, and so on. It should be noted that the touch screen 10 can be a touch module that just has touch function, and can also be a touch display module that has both touch function and display function.

Generally, the distance between the keyboard and the user is significantly less than the distance between the display and the user. Therefore, in comparison to performing touch operation by directly touching the display, inputting information by touch operation on the touch screen 10 provided on the keyboard 1 is more convenient; furthermore, in comparison to the traditional keyboard which inputs information through physical keys, the keyboard 1 according to the embodiment realizes a touching control operation, thus when browsing the Web, pictures, as well as entertaining, the user can obtain more convenient operation experience by sliding operation on the touch screen 10.

For example, in this embodiment, the touch screen 10 is provided with a virtual key region 100 which has virtual keys 101 provided therein and which inputs information by identifying and responding to pressing on the virtual keys 101. Such configuration allows the user to input information by pressing the virtual keys, thereby achieving an inputting efficiency close to or even equal to the inputting efficiency of the traditional keyboard that inputs information through physical keys, thus meeting the demands of the user in the case of requiring a higher inputting efficiency.

In one embodiment, the virtual key region 100 of the touch screen 10 only identifies and responds to the touch action of pressing the virtual keys; that is: when the user touches a region corresponding to virtual keys 101 within the virtual key region 100, the touch screen 10 identifies and responds to the touch action of the user, then the keyboard inputs corresponding information; while when the user touches a region not corresponding to virtual keys 101 within the virtual key region 100, the touch screen 10 does not identify and respond to the touch action of the user. In general, there has an interval between adjacent virtual keys 101, the above configuration can reduce the area of the touch screen 10, thereby reducing cost. And furthermore, the above configuration can also disenable the user to perform continuous sliding operations in the virtual key region 100, but only enable the user to input information by pressing virtual keys 101, this can avoid that the user touches the region corresponding to virtual keys 101 and makes an error operation when performing sliding operations in the virtual key region 100.

In addition to the above virtual key region 100, the touch screen 10 further comprises a sliding operation region 102 which inputs information by identifying and responding to pressing and sliding on the touch screen 10. In the sliding operation region 102, the user can perform sliding operations, thereby obtaining a convenient operation experience in terms of browsing pictures, the Web, as well as entertainment. In one embodiment according to the present disclosure, the aspect ratio of the sliding operation region 102 is the same as the aspect ratio of the display, then such configuration makes the region of the sliding touch region 102 correspond to the display region of the display, and causes the touch of the user on a certain region of the sliding touch region 102 to be mapped to a touch on corresponding region of the touch display and then the information is inputted.

In one embodiment, the virtual key region 100 and the sliding operation region 102 can be defined as fixed regions on the touch screen 10, and the relative position relationship of the two regions does not change during the operation of the keyboard 1. In addition, the virtual key region 100 and the sliding operation region 102 can also be defined as adjustable regions on the touch screen 10, or as regions presented in different usage environments; in this case, for diverse demands of different users, the sizes of the virtual key region 100 and the sliding operation region 102 can be adjusted, even for demands of users in different usage environments, the entire region of the touch screen 10 can be served as the virtual key region 100, or as the sliding operation region 102.

It should be noted that, in addition to the above embodiment in which the touch screen 10 comprises a virtual key region 100 and a sliding operation region 102, in this embodiment, the touch screen 10 can also comprise only a sliding operation region 102, although such configuration cannot meet the demands of the user in the case of requiring a higher inputting efficiency, but compared to performing touch control operations on the current display as well as the traditional keyboard, it is achieved more conveniently that information is inputted by touch control operations.

Referring to FIGS. 2 and 3, FIG. 2 is a back schematic diagram of a keyboard according to the second embodiment of the present disclosure; and FIG. 3 is a side schematic diagram of the keyboard as illustrated in FIG. 2. Compared with the first embodiment, the keyboard 1 according to this embodiment is also provided with a touch screen 10 which has the same structure and function as that of the touch screen described in the first embodiment, which will no be elaborated any more.

Only the difference between the keyboard 1 according to this embodiment and the keyboard according to the first embodiment would be described hereinafter. In this embodiment, the keyboard 1 further comprises physical keys 11 provided on a surface opposite to the surface where the touch screen 10 is located, in order to input information through physical keys 11.

It would be understood that, compared to inputting information through pressing and sliding on the touch region 102 as well as inputting information through pressing virtual keys 101 of the virtual key region 100, the efficiency of inputting information through pressing physical keys 11 is higher, and a feedback can be obtained when pressing, its inputting experience is better, especially for a long-time inputting; therefore, in this embodiment, in the case that the user needs to input information quickly, in particular needs to input information for a long time, the user can overturn the keyboard 1 and use physical keys located on the other surface of the keyboard 1 to input information in order to meet the demand.

In this embodiment, the keyboard 1 further comprises a support device 12 which supports at a surface where the touch screen 10 is disposed or at a surface where physical keys 11 are disposed, to separate the touch screen 10 or physical keys 11 from the support surface for placing the keyboard 1. When the surface where the touch screen 10 is orientated downward or the surface where physical keys 11 are orientated downward, the support device 12 supports the surface where the touch screen 10 is disposed or the surface where physical keys 11 are disposed, this can avoid that the touch screen 10 or physical keys 11 contacts with the support surface and thus information is input incorrectly and normal input is disturbed. It would be understood that, the above support device 12 is also used to adjust the inclined angle of the keyboard 1; by adjusting the inclined angle of the keyboard 1, to meet demands of the user in different usage environments as well as demands of different users.

In one embodiment according to the present disclosure, the support device 12 has an end hinged to the keyboard 1, and the support device 12 supports the keyboard 1 at a surface of the keyboard 1 facing downward. Thus, when the surface where the touch screen 10 is disposed facing downward, the support device 12 is on the side where the touch screen 10 is disposed by rotating the support device around the hinge, this can avoid that the touch screen 10 contacts the support surface, and when the surface where physical keys 11 are disposed facing downward, the support device 12 is at a side where physical keys 11 are disposed by rotating the support device, this can avoid that physical keys 11 contacts the support surface. In the embodiment, only providing the support device 12 for supporting the keyboard 1 at one surface realizes the two surfaces of the touch screen 10 or physical keys 11 of the keyboard 1 do not contact with the support surface.

In this embodiment, in addition to providing the support device 12 to avoid the contact between the touch screen 10 and the support surface causing error input, a gravity sensing device for sensing the orientation of the touch screen 10 can also be provided in the keyboard 1. According to the orientation of the touch screen 10, it can be determined whether the user is using physical keys 11 or is using the touch screen 10. Thus, when the user uses physical keys 11, the touch screen 10 can be turned off to reduce power consumption, and in this case, even if the touch screen 10 contacts the support surface, it will not cause error input. Of course, when the user is using the touch screen 10, the physical keys are turned off. Then, if the physical keys 11 contacts with the support surface, there is no error input caused. In view of preventing error input, there is no need to provide a support device for avoiding contact between the touch screen 10 and the support surface. But it can be understood that the support device can still be provided to adjust the inclined angle of the keyboard 1. When the user needs to use the touch screen 10, the touch screen 10 can be automatically turned on in order to facilitate the usage of the user.

It is determined whether the user is using the touch screen or not according to the orientation of the surface on which the touch screen 10 is disposed or the surface where physical keys 11 are disposed. In one embodiment according to the present disclosure, when the touch screen 10 facing downward, it is determined that the user is using physical keys 11, then the touch screen 10 is turned off; when the touch screen 10 facing upward, it is determined that the user is using the touch screen 10, then the touch screen 10 is turned on.

From the above, the keyboard 1 according to embodiments of the present disclosure is provided with the touch screen 10, the user can be enabled to input information through the touch screen 10, which brings the user a more convenient and fast operation experience; furthermore, the user performs a touching control operation on the keyboard 1 without touching the display far from the user, thereby making the touching operation more convenient.

What are described above is related to the illustrative embodiments of the disclosure only and not limitative to the scope of the disclosure; the scopes of the disclosure are defined by the accompanying claims.

This disclosure claims the benefit of Chinese patent application No.201410686663.3, filed Nov. 24, 2014, the disclosure of which is hereby incorporated herein by reference in its entirety.

1. A keyboard comprising a touch screen which identifies and responds to a touch action, wherein information is input through the touch screen.

2. The keyboard of claim 1, wherein the touch screen is provided with a virtual key region which has virtual keys provided therein, information is input through the touch screen by identifying and responding to pressing operation on the virtual keys.

3. The keyboard of claim 2, wherein the touch screen only identifies and responds to the touch action of the virtual keys.

4. The keyboard of claim 1, wherein the touch screen comprises a sliding operation region, information is input through the touch screen by identifying and responding to pressing and sliding on the sliding operation region.

5. The keyboard of claim 2, wherein the touch screen comprises a sliding operation region, information is input through the touch screen by identifying and responding to pressing and sliding on the sliding operation region.

6. The keyboard of claim 3, wherein the touch screen comprises a sliding operation region, information is input through the touch screen by identifying and responding to pressing and sliding on the sliding operation region.

7. The keyboard of claim 4, wherein the aspect ratio of the sliding operation region is identical to the aspect ratio of the display.

8. The keyboard of claim 5, wherein the aspect ratio of the sliding operation region is identical to the aspect ratio of the display.

9. The keyboard of claim 6, wherein the aspect ratio of the sliding operation region is identical to the aspect ratio of the display.

10. The keyboard of claim 1, wherein the keyboard further comprises physical keys provided on a surface opposite to a surface where the touch screen is located.

11. The keyboard of claim 10, wherein the keyboard further comprises a support device which supports the keyboard at the surface where the touch screen is disposed or at the surface where physical keys are disposed, to separate the touch screen or the physical keys from the support surface for placing the keyboard.

12. The keyboard of claim 11, wherein the support device has an end hinged to the keyboard.

13. The keyboard of claim 10, wherein the keyboard comprises a gravity sensing device for sensing an orientation of the touch screen or physical keys.

14. The keyboard of claim 11, wherein the keyboard comprises a gravity sensing device for sensing an orientation of the touch screen or physical keys.

15. The keyboard of claim 12, wherein the keyboard comprises a gravity sensing device for sensing an orientation of the touch screen or physical keys.

16. The keyboard of claim 13, wherein the touch screen is turned off when facing downward and is turned on when facing upward.

17. The keyboard of claim 14, wherein the touch screen is turned off when facing downward and is turned on when facing upward.

18. The keyboard of claim 1, wherein the touch screen is a touch module that only has touch function.

19. The keyboard of claim 1, wherein the touch screen is a touch display module that has both touch function and display function.

20. The keyboard of claim 10, wherein the touch screen is a touch display module that has both touch function and display function.
